(19) United States
(12) Patent Application Publication
(10) Pub. No.: US 2001/0044851 A1
(43) Pub. Date: Nov. 22, 2001

(54) System and method for reducing the resources required to deliver streaming media

(76) Inventors: Peter Lorin Rothman, San Francisco, CA (US); John Toupin, San Mateo, CA (US); Brian M. Lomeland, Phoenix, AZ (US); Craig Matthew Milito, Burlingame, CA (US)

Correspondence Address: Anthony R. Barkume, Greenberg Traurig, LLP, 200 Park Avenue, New York, NY, 10166, US

(21) Appl. No.: 09/844,540

(22) Filed: Apr. 27, 2001

Related U.S. Application Data
(60) Provisional application No. 60/200,410, filed on Apr. 28, 2000.

(51) Int. Cl. G06F 15/16

(52) U.S. Cl. 709/231

(57) ABSTRACT

A scalable architecture delivers real-time streaming media over a communications network, using a streaming media server system for efficient delivery of a plurality of streams including live, simulated live or looping programming, relayed streams, and on-demand media is described. Efficiency is attained using no load or low load control and processing of streams, including high-quality audio, video, graphics, text, or other types of information transmitted over a network. The server system operates in a total media delivery system which includes a plurality of streaming servers, a data storage system, a database, and front end and back end networks to deliver data to the various subsystems. The streaming server utilizes just-in-time playlist simulation, dynamic allocation of servers to listeners, and other techniques to reduce the computational, storage and network requirements of delivering streaming media.

### CROSS-REFERENCE TO RELATED APPLICATIONS

This application is related to and claims priority from U.S. provisional application number 60/200,410, filed Apr. 28, 2000, the specification of this provisional application being incorporated herein by reference.

### FIELD OF THE INVENTION

The present invention relates generally to the field of media delivery over communication networks, and in particular to the streaming of media such as audio and video streaming.

### BACKGROUND OF THE INVENTION

With improvements in processor speed, compression technology, and network bandwidth, real-time streaming is becoming more popular. Applications of such servers include delivery of Internet-based radio, talk radio, distance learning, Internet rebroadcast of terrestrial TV and/or radio signals, and many others.

Most existing streaming media systems fail to be optimized for delivery of very large numbers of streams since they were not developed to operate in a multi-stream environment.

Data to be sequentially transferred in real-time, such as video data and audio data, are generally called “real-time stream data”. For a real-time stream server for handling such real-time stream data, a necessary condition is that it should be able to transfer the real-time stream data stored in disk devices to each client while guaranteeing a continuity in real-time.

The computational, storage, and network bandwidth required to operate a large streaming media system are substantial. Each user connecting to such a system requires software to execute that retrieves media data from mass storage and delivers it across the network to an end user employing a player application. Thus the computational requirements increase as the number of listeners increases.

Since each stream broadcast requires data to be retrieved from storage and delivered to the streaming server, the number of broadcasts directly impacts the costs of both the backside network and the storage system itself. The number of media files held in mass storage impacts storage costs, and this is related directly to the number of streams offered.

While a stream is being delivered to a user, other non-streaming data may need to be delivered along with stream. This data may be synchronized or unsynchronized with the stream. Because individuals who are not professional content creators or media programmers create the majority of the broadcasts, and because there are literally thousands of broadcasts from which to choose, the distribution of listeners to broadcasts is fairly narrow. Additionally, broadcasts may persist over time, in some cases operating 24 hours a day, 7 days a week, 365 days a year, allowing listeners to come and go during the life of a broadcast. This means that many broadcasts have a very small number or even no listeners at any given time, while only a small number of broadcasts will have a large listenership. This is analogous to most user-generated content, for example, personal homepages, where a relatively small percentage of total homepages generate a very large percent of all traffic, while the majority have few, and sometimes very few, visitors.

In an on-demand system, the streaming server remains idle until a listener/viewer connects to it. The on-demand stream consists of stored prerecorded files which are delivered to the audience when requested. Also, each listener initiates a new stream and these streams are not synchronized with each other.

In a live broadcast, the stream is originated from a live event such as a live musical performance, sporting event, etc. All listeners/viewers of the streaming content receive a synchronized stream and have a shared experience. However, in the case of the live stream, the server must operate even if there are no listeners. In simulated live broadcasting, the streaming server uses prerecorded files as in the on-demand case, but continually broadcasts these files as if the stream were originating from a live source.

Current streaming media delivery systems were developed and intended to broadcast large events and to scale upward for very large audiences. However, they are very inefficient in the case when many broadcasts have few listeners. In particular these servers consume system resources (i.e. CPU time, storage, network bandwidth) even when the stream has no listeners and the resources they utilize scale at least linearly with the number of broadcasts offered.

As a result, a service trying to deliver streaming media broadcasting service to a large audience of broadcasters and listeners cannot be constructed in an efficient or economically feasible manner because the scale and cost of the system increases with the number of active (or even looping, canned, or otherwise “inactive” or less active) broadcasters, rather than simply as a function of the number of listeners.

In the prior art, multi-casting apparatus and methods are known, for example, as described in U.S. Pat. Nos. 5,778,187; 6,119,163; and 6,6061,504. Known prior art systems and methods suffer from performance limitations and inefficient operation due to their inability to handle or address the load demands of large scale media streaming with diverse and dynamic load requirements.

A need exists for a system and method capable of providing media streaming in communications networks of diverse scalability, including the Internet, in order to, for example, handle the streaming demands of thousands of users simultaneously as well as to address dynamic load requirements for such streaming.

### SUMMARY OF THE INVENTION

The disclosed streaming media delivery system and method described herein provide efficient operation of streaming using several component subsystems. The streaming media delivery system includes a directory server which lists the programs that are available to stream, a stream database, a streaming server, a media database, an advertising insertion server, and a database for storing information about each stream. In the preferred embodiment, audio data is delivered from the streaming media delivery system, and information about each song such as the artist, song title, and CD or album name are also delivered synchronously. A playlist server delivers information synchronized to playlist entries for display in the player browser window.

The directory server creates a listing of the available stations and/or programs which can be selected by users of the streaming media system. When a program is selected, a player window is created, which is an instance of the user's preferred web browser. The player window includes an instance of a “thin client”, such as a small application program, a “MICROSOFT ACTIVEX” control, or an applet, such as a “JAVA”-based applet, which can receive streaming media and present this media to the user.

The streaming server is responsible for the actual delivery of media data to users of the streaming media system. The streaming server operates in several different modes and delivers data differently depending on its operating mode. In the first three of these modes (basic/looping, relay, and live), users of the streaming media system which are accessing a stream all receive the same data. This data can be delivered via Internet protocol (IP) unicast or multicast. However, in on-demand mode, each user receives an individualized stream delivered by unicast.

In basic/looping mode, the streaming server operates from a stored playlist or a randomly generated playlist and, based on this playlist, retrieves files from the media storage system and delivers this data over the frontside network and the Internet to users of the service. In this mode, the program delivered by the streaming server is always running, so any users that connect at a later time will join it in progress. The streaming server cannot be paused in this mode.

In live broadcasting mode the streaming server is delivered a stream from a live broadcasting tool which can either play a playlist from locally stored files, audio from a microphone or line in, or a mixture of these sources, and the streaming server cannot be paused in this mode.

In relay mode, the streaming server takes a stream from another server and repeats it. The streaming server cannot be paused in this mode.

In on-demand mode, a stream such as an audio stream is delivered to each individual user that connects to the streaming server. The streaming server retrieves files as needed by each user. Users can pause and resume programs in progress when the streaming server operates in this mode.

Additionally, in the preferred embodiment, delivery of synchronized data such as visual information (CD cover art, artist information), promotional materials (i.e. banner advertisements, buttons), and commerce opportunities (buy the CD you are hearing, buy concert tickets for the current artists upcoming show) is also delivered to the user, with such delivery being synchronized with the stream.

Much of this synchronous content is relevant to the audience of listeners/viewers before they connect to a stream. For example, a potential listener to a streaming radio station might be interested in finding streams currently playing a specific artist. However, unless the stream is active (i.e. playing and using system resources) the synchronous content is not generated or available.

Furthermore the rights of web broadcasters such as “LIVE365” to deliver commercial content are governed in the United States by the Digital Millennium Copyright Act of 1999 (DMCA). The DMCA dictates the rules under which Internet broadcasters can broadcast commercial content over the Internet. One of the requirements of the DMCA is that the listeners should not be able to predict the playlist in advance. If a station has a static playlist, on-demand broadcasting is perfectly predictable. But simulated live broadcasting as implemented by current streaming servers scales with the number of broadcasters, not with the number of listeners, and therefore is infeasible for large systems in which there are many stations with no listeners.

Accordingly, since it is necessary for the data storage unit in a streaming system to store a large amount of data and to transfer data at high speed, a striping technique is usually employed with the data storage unit, in which a disk array device is provided by combining a plurality of disk devices, and having data sequentially stored over all the disk devices by being divided into small blocks.

In addition, the real-time stream server is required to be capable of continuing a supply of a connected stream, and restoring data without stopping the server operation, even when a disk device is disabled. For this reason, for the data storage unit of the real-time stream server, a fault detection means for detecting a disabled disk device and a disk device exchange means for exchanging disks during the server operation are provided.

A media file server includes an integrated cached disk array storage subsystem and a plurality of stream server computers linking the cached disk storage subsystem to the data network for the transfer of audio and/or video data streams. The media file server further includes a controller server for applying an admission control policy to client requests and assigning stream servers to service the client requests.

It is therefore an object of this invention to provide an audio data transmission system which is scaleable so as to efficiently deliver streaming media in a multi-broadcaster/multi-listener environment.

It is therefore an object of the present invention to provide a real-time stream server and a method for operating a real-time stream server efficiently, so that it is capable of realizing a supply of a plurality of real-time stream data, without wasting computational resources, network bandwidth, or the transfer capacity of disk devices.

According to one object of the present invention, there is provided a real-time streaming media system, including:

a user's receiving terminal;

a display device capable of receiving and displaying HTML, XML, and/or ASCII text for display; and

a player for receiving and playing streaming audio.

This terminal connects via the Internet to a streaming media server system including:

web servers for delivering HTML data using a playlist window;

streaming servers for delivering real-time media data such as audio and/or video;

a directory server which lists all available programs or streams which are available from the service;

a playlist server for delivering non-streaming data synchronized with track listings in playlists; and

an advertising insertion server which inserts audio and/or video advertising content into a stream at a preprogrammed frequency or to reach specifically selected users that are connected to the streaming server.

In accordance with the invention, the streaming media system includes a cached disk storage subsystem. The cached disk storage substation is responsive to media prefetch commands for staging data specified by a process from a disk array of the cached disk storage subsystem to an allocated portion of the cache memory when the data are absent from the cache memory, and the cached disk storage substation is responsive to a fetch command for fetching data specified by the process from cache memory of the cached disk storage subsystem.

The data specified for the prefetch command for the process are retained in the allocated portion of the cache memory from the time that the cached disk storage substation has responded to the prefetch command to the time that the cached disk storage substation responds to a fetch command specifying the data for the process. After the cached disk storage subsystem responds to the fetch command, the allocated portion of cache memory holding the specified data is freed for receiving different data so long as the cached disk storage substation has not yet processed a prefetch command in which the data have been specified by another process that has not yet fetched the data.

A buffer memory is included for temporarily storing the blocks read out from the plurality of disk devices. Control means is provided for reading out the blocks constituting the real-time stream data from the plurality of disk devices to the buffer memory, and for reading out the real-time stream data from the buffer memory, according to a request for the real-time stream data from a client. Transfer means is also included for transferring the real-time stream data read out from the buffer memory to the client through a network.

In order to operate such a system most efficiently, servers with no client connections need not retrieve data from the storage system. There are two methods to achieving this efficiency.

In a low load method, the streaming server does not run, but the database keeps track of information and synchronous data continues to be updated in real-time. This reduces the resources required to deliver this content by avoiding the need to read files from the file storage system, to move this data across the internal network, or to consume CPU time performing these operations. However, since the playlist is being actively read, a limited amount of CPU time is consumed reading this data and updating the synchronous data list.

In a zero load method, no processing is performed at all when there are no listeners/viewers for a stream. When a listener does connect, a calculation is performed to determine what track should be delivered to the user. The calculation is performed by using the stored playlist which includes the knowledge of the length of each track, the period of “off” time that is required to link one track with the subsequent one, and the time of the last connection to the stream which is recorded when the last person disconnects from the stream. The proper track to deliver is calculated by comparing the time since the last connection to the sequence of tracks in the playlist, and determining which track would have been playing if the stream had been playing continuously. This calculation method is used upon connection for the first listener/viewer when the server was idle for some period of time, but all subsequent connections are handled by the normal live streaming logic.

The directory server is periodically contacted by the streaming server to report current listener counts and other data. When a very large number of servers is operated and these updates are frequent, a very high load can be imposed on the directory server and the database in which the station/program data are stored. In the present invention, the streaming servers only contact the directory server when there are user connections to the streaming server.

Additionally, when a large number of users are requesting access to the directory, a large number of pages (HTML, XML, or ASCII data) need to be delivered. Since many of these requests are repetitive, the current invention includes the caching of requests and results to eliminate repetitive queries from being submitted to the database.

The playlist server is contacted by the streaming server whenever a new track or playlist entry begins playing. When a very large number of streams are delivered to a large number of users, a very large number of playlists must be generated. In the current invention, if a station has no connected users, the playlist need not be generated.

In another optional aspect of the current invention, when a user connects as the first user to a given program, a streaming server is assigned to deliver the program from a pre-allocated pool of free/available servers. This pool is started in advance, and remains running but unassigned until requested by a user.

In the present invention, when a user attempts to connect to a stream that already has an assigned server, the user is routed to the existing server delivering that stream, with the exception of on-demand programming in which each user is assigned his/her own server.

In the present invention, a clerk device is responsible for routing incoming user requests to the proper streaming server, and for assigning a streaming server to programs.

Other features and advantages of the present invention will become apparent from the following description taken in conjunction with the accompanying drawings.

### BRIEF DESCRIPTION OF THE DRAWINGS

FIG. 1 illustrates a schematic of the disclosed streaming data delivery system in a networked configuration with a client device.

FIG. 2 illustrates the components of FIG. 1 in greater detail.

FIG. 3 illustrates a method for performing streaming functions in multiple operating modes.

FIG. 4 illustrates a method for streaming data and responding to load activity to control the streaming.

FIG. 5 illustrates a method for no load processing to control the streaming of FIG. 4.

FIG. 6 illustrates a method for low load processing to control the streaming of FIG. 4.

FIG. 7 illustrates a schematic of a streaming application using APIs to interface with servers and other networked components.

### DETAILED DESCRIPTION OF THE PREFERRED EMBODIMENTS

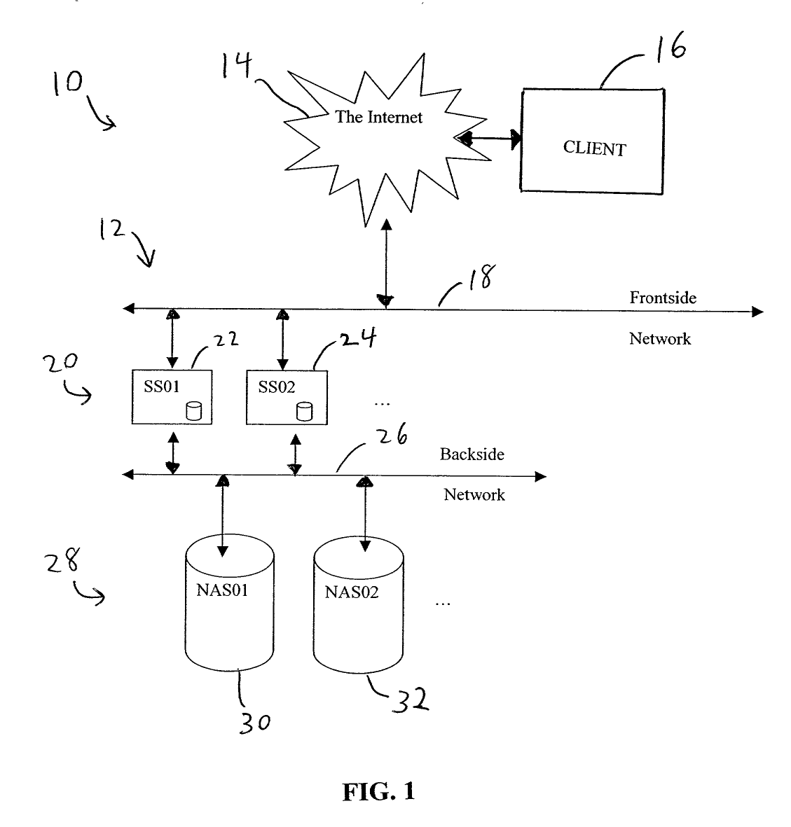

Turning now to FIG. 1 of the drawings, there is shown a media server system 10 incorporating and implementing the streaming media delivery system and method of the present invention. The media server system 10 includes a media file server 12 connected to the Internet 14 and/or other networks, and thence to at least one client 16 associated with a user, for streaming data from the media server 12 to the client 16, such as any known type of computing device such as a personal computer or a hand-held computing device. The connections between the media server 12, the Internet 14, and the client 16 may be by wired or wireless connections, or any combination thereof. The streaming data may include at least one of audio data, video data, multimedia data, text data, and/or any combination thereof in an appropriate format to be received and accessed by a user at the client 16.

The media file server 12 includes a frontside network 18, an array 20 of at least one stream server subsystem (SS) 22-24 connected to a frontside network 18, and a backside network 26 connected to an integrated cached disk array storage subsystem 28 including at least one network application storage (NAS) device 30, 32. The media file server 12 is a high performance, high capacity, and high-availability network-attached data server configuration which provides the ability for multiple file systems to exist concurrently over multiple communication stacks with shared data access. The media file server 12 also allows multiple physical file systems to co-exist, each optimized to the needs of a particular data service.

### The Underlying Network Configuration

The media file server 12 is implemented as a dedicated network appliance, integrated with and/or operating with known network operating systems such that, other than its superior performance, the media file server 12 and its operation are transparent to the end user using the client 16. The media file server 12 also provides specialized support for isochronous data streams used in live, as well as store-and forward, audio-visual applications. Therefore, the media file server 12 is suitable for a wide variety of applications such as image or audio file repositories, Internet radio, video on-demand, and networked video applications, in addition to high-end file server applications such as the Network File System (NFS) and/or other access protocols, network or on-line backup, fast download, etc. NFS is a well-known IETF file access protocol standard, described in “NFS: Network File System Protocol Specification”, Sun Microsystems, Inc., RFC 1094, Mar. 1, 1989. The disclosed streaming system and method, including the media file server 12, are implemented on such known network-based systems such as the NFS, for example, as described in U.S. Pat. No. 6,212,640, which is incorporated herein by reference. NFS acts as a network server for network communications by providing basic file access operations for network clients. Such basic file access operations include opening a file, reading a file, writing to a file, and closing a file.

The clustering of the stream server subsystems 22, 24 as a front end to the integrated cached disk array 28 provides parallelism and scalability. The clustering of random-access memory in the stream server subsystems 22, 24 provides a large capacity cache memory for streaming media applications.

Each of the stream server subsystems 22, 24 is a high-end commercially available computer, providing the highest performance appropriate for a stream server at the lowest cost. The stream server subsystems 22, 24 are mounted in a standard configuration, such as a nineteen inch rack. In the preferred embodiment, the stream server subsystems 22, 24 are implemented either with “NETRA T1125” or “ULTRASPARC-II” systems available from “SUN MICROSYSTEMS”.

In the preferred embodiment, a dual processor “NETRA T1125” is used as the memory of the stream server subsystems 22, 24 with, for example, about 2 Gigabits of main memory, about 20 Gigabits of local disk storage, about 300 MHz CPU, and between about two and five sets of 100 Megabit Ethernet ports.

The number of the stream server subsystems 22, 24 in the array 20, their processor class, and the amount of random-access memory in each of the stream server subsystems 22, 24 may be selected for desired performance and capacity characteristics, such as the number of concurrent users to be serviced, the number of independent multi-media programs to be accessed concurrently, and the desired latency of access to the multi-media programs, as described herein. Load balancing is provided, for example, by a “BIG/IP HA+” load balancing system available from “F5LABS” in one or more of the stream server subsystems 22, 24 or, separately, as a load balancing device incorporated in the frontside network 18.

The databases associated with the stream server subsystems 22, 24 are implemented by an “ENTERPRISE 4500” database available from “SUN MICROSYSTEMS”, and running on an “ORACLE 8i” database server available from “ORACLE”. In the preferred embodiment, about 10 CPUs, each of which is running “ORACLE” databases, are included in the database servers, as described herein.

In the preferred embodiment, each of the storage subsystems 30, 32 is a “NETWORK APPLIANCE 740” storage device available from “NETWORK APPLIANCE”, with about 1 Terabyte of storage and two filer heads for fault tolerance. In the preferred embodiment, multiple “NETWORK APPLIANCE” storage devices 30, 32 are connected to the backside network 26 via two Gigabit Ethernet cards.

Two “CISCO 6509” switch/routers, available from “CISCO SYSTEMS”, provide fault tolerant network connectivity and TCP/IP routing for the backside network 26, with fail over and load balancing between the two switches. Each “CISCO 6509” switch/router includes two supervisor engine (SUP) cards with Multilayer Switch Feature Card (MSFC), router cards, four 48 port 100 Megabit cards, and two 16 Port 1000 Megabit cards.

In the preferred embodiment the “NETRA 1125” systems of the stream server subsystems 22, 24 are also used to perform application serving, such as for the playlist and directory servers described herein, as well as operating a firewall and facilitating web serving. The media file server 12 may also include web servers, such as those web servers available from “APACHE”, which are implemented to include the ability to execute PERL and server side code implementing “JAVA”, available from “SUN MICROSYSTEMS”.

In the preferred embodiment, the media file server 12 includes an integrated cached disk array storage subsystem 28 and a plurality of stream server computers 22, 24 linking the cached disk storage subsystem 28 to the data network 26 for the transfer of audio and/or video data streams. The media file server 12 may also include a controller server for applying an admission control policy to client requests and assigning stream servers to service the client requests.

### The Streaming Application

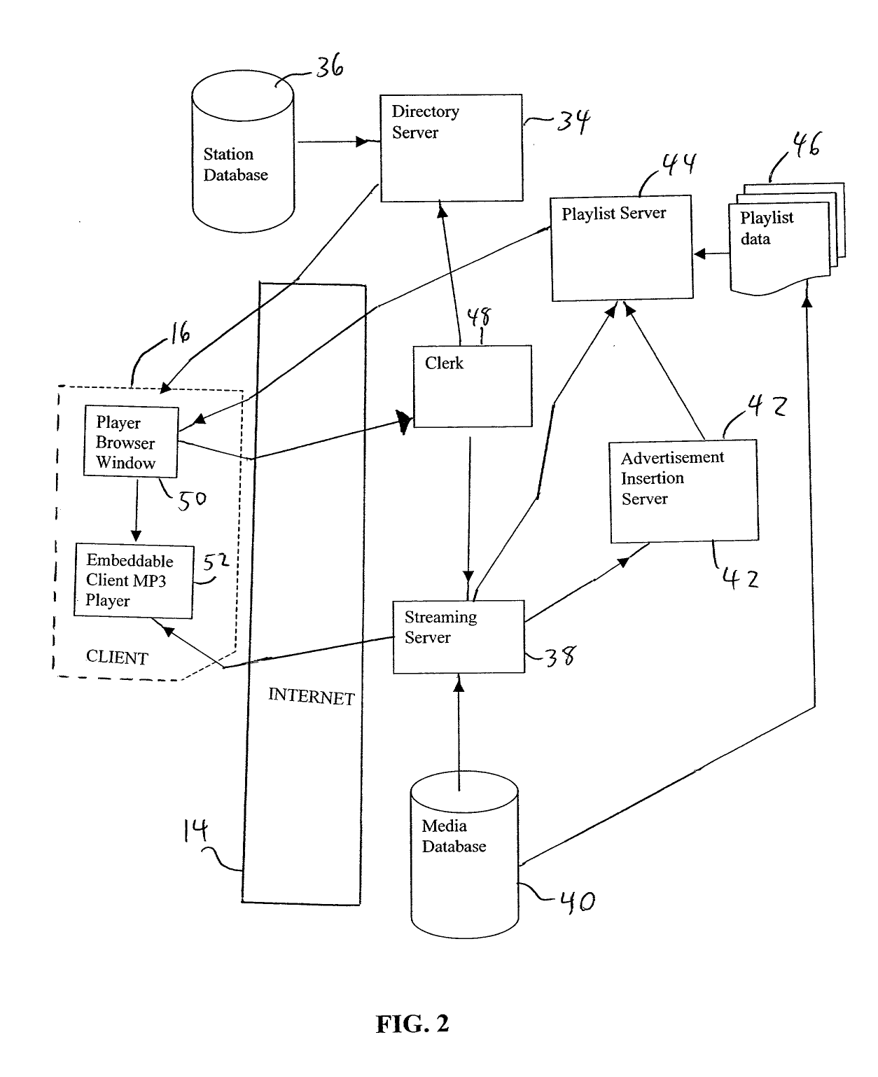

The disclosed streaming media delivery system and method described herein provide efficient operation of streaming using the media file system 12 having several component subsystems, as shown in greater detail in FIG. 2. In implementing the streaming media delivery system and method, the media file system 12 includes, in at least one of the stream server subsystems 22, 24, a directory server 34 which lists the programs that are available to stream, a stream database 3 6, a streaming server 3 8, a media database 40 which may be included in the storage systems 30, 32, an advertising insertion server (AIS) 42, and playlist server 44 including a database for storing information about each stream, such as playlist data 46.

In an example embodiment, audio data is delivered from the streaming media delivery system, and information about each song such as the artist, song title, and CD or album name are also delivered synchronously. A playlist server delivers information synchronized to playlist entries for display in the player browser window. It is to be understood that, while audio data is used herein to describe the operations of the disclosed streaming delivery system and method, data not limited to audio may also be stored, accessed, transferred, and/or streamed, such as video, multimedia, and text data and/or any combination thereof with or without audio data.

In another optional aspect of the current invention, when a user connects as the first user to a given program, a respective streaming server 38 is assigned to deliver the program from a pre-allocated pool of free/available servers. This pool is started in advance, and remains running but unassigned until requested by a user.

In the present invention, when a user attempts to connect to a stream that already has an assigned server, the user is routed to the existing server delivering that stream, with the exception of on-demand mode in which each user is assigned their own server.

In the present invention, a clerk device 48 is responsible for routing incoming user requests to the proper streaming server 38, and for assigning a respective streaming server 38 of the server subsystems 22, 24 to programs.

The directory server 34 creates a listing of the available stations and/or programs which can be selected by users of the streaming media system. When a program is selected, a player window 50 is created at the client 16, which is an instance of the user's preferred web browser. The player window 50 includes an instance of a “thin client”, such as a small application program, a “MICROSOFT ACTIVEX” control, or an applet, such as a “JAVA”-based applet, implemented by an embeddable player 52, such as an embeddable client MP3 player, which can receive streaming media and present this media to the user at the client 16.

### Modes of Streaming Operation

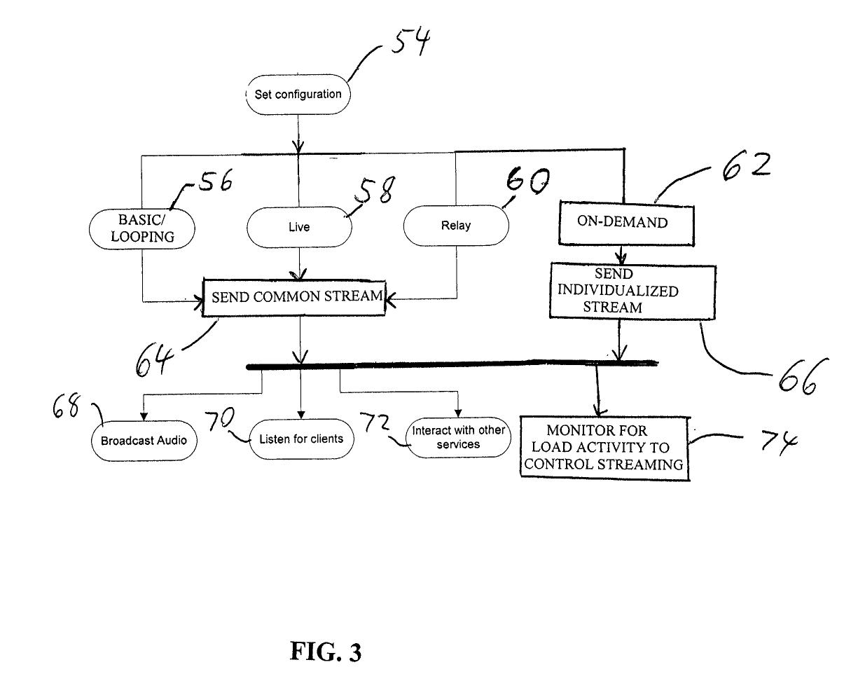

The streaming server 38 is responsible for the actual delivery of media data to users of the streaming media system. The streaming server 3 8 operates in several different modes and delivers data differently depending on its operating mode, as shown in FIG. 3.

The streaming server 38 supports four major modes of broadcasting: Live, Relay, Basic/Looping, and On-Demand. The core component of this service executed on the streaming server is a streaming application, which may be implemented in the “NANOCASTER” software available from “LIVE365”. The streaming application is written in the C programming language and runs on the “SOLARIS” operating system available from “SUN MICROSYSTEMS”. The streaming application is optimized to run hundreds or even thousands of stations simultaneously on a single streaming server CPU.

The streaming application is server software running on the streaming server 38 which streams, in an example implementation, audio data contained in files, for example, in the MP3 format, to many clients 16 connected through the Internet 14. The streaming application may be used in several different ways. The most common instance of the streaming application is streaming in a Basic/Looping mode, also called “EASYCAST” mode provided by “LIVE365”, in which the streaming application takes a pre-compiled playlist of audio files, and sequentially or randomly streams the data contained in those files to clients 16 connected over the Internet 14. In Relay mode, the streaming application may also be used to relay audio broadcasts. The streaming application can be configured to act as a listener to an audio stream on the Internet 14, and to rebroadcast utilizing client handling and scalability provided by the streaming application.

In Live mode, the streaming application may be used to implement live broadcasts over the Internet using client software to record, and to encode the audio to be broadcast by the streaming application. The streaming application manages the sending of the necessary amount of data to each client connected.

The streaming application logs listener access, including the time connected, the audio software that the listener used to connect to the broadcast, and any cookie information passed on through an accessed website for such audio, such as the website at http://www.live365.com available from “LIVE365”. The streaming application logs the listener counts at the start and at the end of an audio clip.

More specifically, the modes include Basic/Looping mode, in which a broadcast originates from locally stored files; Live mode, in which a live source is sent to the streaming application for rebroadcast; Relay mode, in which the streaming application grabs a source stream from elsewhere and rebroadcasts it; and On-Demand mode, in which the streaming application delivers a stream upon the selection of a specific individual.

The streaming application is responsible for connecting listeners to a source and for keeping data flowing to the directory and playlist services. The vast majority of stations providing such services and programs operate in Basic/Looping mode, in which the streaming application streams a playlist of MP3 files hosted on the main file system, for example, through the “LIVE365” website. In Relay mode, the streaming application actively reads data from a non-“LIVE365” IP address, whereas in Live mode, the streaming application monitors or “listens” on a particular local IP address for a source data stream and retransmits any detected data stream. For Basic/Looping broadcasts, the streaming application reads a playlist file, opens the next MP3 file to be streamed, and streams its contents to each active listener. The streaming application reads an ID3 tag from the MP3 file, and accesses or calls a playlist server providing a playlist service to keep the playlist server up-to-date. The streaming application also access or calls various directory service routines to keep the station directory database up-to-date.

Because the streaming server 38 handles both the content origination and delivery, the streaming server 38 knows both what it is playing and to whom it is playing, which uniquely enables the streaming server 3 8 to deliver customized audio content to its listeners while drawing on very few system resources when there are few or no listeners.

The streaming application produces log files that can be analyzed and certified by independent third parties. These logs track which songs are played and to how many listeners.

The streaming application provides a massively scalable backend solution for streaming, and natively supports current data formats, for example, the audio format known as MP3. The streaming application is extensible to handle any future type of available audio or video formats. The streaming application interoperates with an extensive set of known streaming players such as the player 52, and known software functions and tools to reach a diverse listener and broadcaster base.

A plurality of instances of the streaming application are executed as individual processes, with each broadcast provided by a respective streaming application. The number of streaming applications that can run on one host may be limited, for example, only by the amount of memory present in the host computer and by any limitations of the host computer's operating system. Each broadcast is assigned a TCP/IP port, and so if one streaming application is having problems, only the broadcast corresponding to the problem streaming application needs to be restarted, and so not every broadcast on that computer with the problematic streaming application needs to be restarted. Each instance of the streaming application has virtually no CPU impact when it is running, and each streaming application is optimized to handle, for example, over 2,000 concurrent client connections running in one process.

As shown in FIG. 3, a user selects, through the client 16, the operation to be performed for streaming by setting a configuration in step 54. Depending on the setting, the streaming system and method enters the basic/looping state 56, the live state 58, the relay state 60, or the on-line demand state 62. In the first three of these modes (basic/looping, relay, and live), users of the streaming media system which are accessing a common stream all receive the same data. This data can be delivered via Internet protocol (IP) unicast or multicast. However, in on-demand mode, each user receives an individualized stream delivered by unicast.

Accordingly, the streaming system and method performs step 64 to send common data, or performs step 66 to send an individualized stream. The streaming system and method then concurrently perform steps 68-74 to broadcast data such as audio data in step 68, to monitor/listen for other clients 16 accessing the streaming system and method in step 70, to interact with other services in step 72 such as third party audio data sources, and to monitor for load activity in step 74 to control the streaming, for example, in low or zero load operations as described herein.

In basic/looping mode, the streaming server 38 operates from a stored playlist or a randomly generated playlist and, based on this playlist, retrieves files from the media storage system 28 and delivers this data over the frontside network 18 and the Internet 14 to users at clients 16 of the service. In this mode, the program delivered by the streaming server 38 is always running, so any users that connect at a later time will join it in progress. The streaming server 38 cannot be paused in this mode.

In live broadcasting mode, the streaming server 38 is delivered a stream from a live broadcasting tool which can either play a playlist from locally stored files, audio from a microphone or line in, or a mixture of these sources, and the streaming server 38 cannot be paused in this mode.

In relay mode, the streaming server 38 takes a stream from another server and repeats it. The streaming server 38 cannot be paused in this mode.

In on-demand mode, a stream such as an audio stream is delivered to each individual user that connects to the streaming server. The streaming server 38 retrieves files as needed by each user. Users can pause and resume programs in progress when the streaming server 38 operates in this mode.

Additionally, in the preferred embodiment, delivery of synchronized data such as visual information (CD cover art, artist information), promotional materials (i.e. banner advertisements, buttons), and commerce opportunities (buy the CD you are hearing, buy concert tickets for the current artists upcoming show) is also delivered to the user, with such delivery being synchronized with the stream.

Much of this synchronous content is relevant to the audience of listeners/viewers before they connect to a stream. For example, a potential listener to a streaming radio station might be interested in finding streams currently playing a specific artist. However, unless the stream is active (i.e. playing and using system resources), the synchronous content is not generated or available.

Furthermore, the rights of web broadcasters such as “LIVE365” to deliver commercial content are governed in the United States by the Digital Millennium Copyright Act of 1999 (DMCA). The DMCA dictates the rules under which Internet broadcasters can broadcast commercial content over the Internet 14. One of the requirements of the DMCA is that the listeners should not be able to predict the playlist in advance. If a station has a static playlist, on-demand broadcasting is perfectly predictable. But simulated live broadcasting as implemented by current streaming servers scales with the number of broadcasters, not with the number of listeners, and therefore is infeasible for large systems in which there are many stations with no listeners.

Accordingly, since it is necessary for the data storage unit in a streaming system to store a large amount of data and to transfer data at high speed, a striping technique is usually employed with the data storage unit 28, in which a disk array device is provided by combining a plurality of disk devices 30, 32, and data are sequentially stored over all the disk devices 30, 32 by being divided into small blocks.

In addition, the real-time streaming server 38 is required to be capable of continuing a supply of a connected stream, and restoring data without stopping the server operation, even when a disk device is disabled. For this reason, for the data storage unit of the real-time streaming server 38, a fault detection device or technique, such as those known in the art, is used for detecting a disabled disk device, and a disk device exchange device or technique, such as those known in the art, is used for exchanging disks during the server operation.

### The Client Device

The client 16 or client device may be any known computing device for facilitating data access and use, such as playback of received media data including audio data, video data, etc. In a preferred embodiment, the client 16 includes a user's receiving terminal; a display device capable of receiving and displaying HTML, XML, and/or ASCII text for display; and a player such as the embeddable client MP3 player 52 for receiving and playing streaming audio. This terminal of the client 16 connects via the Internet 14 to a streaming media server system 12 having, in an example embodiment, web servers for delivering HTML data using a playlist window; the streaming servers 38 for delivering real-time media data such as audio and/or video; the directory server 34 which lists all available programs or streams which are available from the service; the playlist server 44 for delivering non-streaming data synchronized with track listings in playlists using playlist data 46; and the advertising insertion server 42 which inserts audio and/or video advertising content into a stream at a preprogrammed frequency or to reach specifically selected users that are connected to the streaming server 38.

In accordance with the invention, the streaming media system includes a cached disk storage subsystem formed by the storage devices 30, 32 of the array 28, which may include the station database 36 and the media database 40. The cached disk storage subsystem is responsive to media prefetch commands for staging data specified by a process from the disk array 28 of the cached disk storage subsystem to an allocated portion of the cache memory when the data are absent from the cache memory, and the cached disk storage subsystem is responsive to a fetch command for fetching data specified by the process from cache memory of the cached disk storage subsystem.

The data specified for the prefetch command for the process are retained in the allocated portion of the cache memory from the time that the cached disk storage substation has responded to the prefetch command to the time that the cached disk storage substation responds to a fetch command specifying the data for the process. After the cached disk storage subsystem responds to the fetch command, the allocated portion of cache memory holding the specified data is freed for receiving different data so long as the cached disk storage substation has not yet processed a prefetch command in which the data have been specified by another process that has not yet fetched the data.

A buffer memory may also be included, in the array 28 and/or in the streaming server 38, for temporarily storing the blocks read out from the plurality of disk devices. Control devices known in the art are used for reading out the blocks constituting the real-time stream data from the plurality of disk devices to the buffer memory, and for reading out the real-time stream data from the buffer memory, according to a request for the real-time stream data from the client 16. Transfer devices known in the art are also included for transferring the real-time stream data read out from the buffer memory to the client 16 through a network such as the Internet 14.

### Low and Zero Load Streaming Operations

In order to operate a streaming system and method most efficiently, streaming servers 38 with no client connections need not retrieve data from the storage system 28. There are two methods used to operate in such conditions and so to achieve such efficiency: using a zero/no load method and using a low load method to control the streaming server 38, for example, in response to monitoring the load conditions and/or current operations of the programs and clients, for example, in step 74 in FIG. 3.

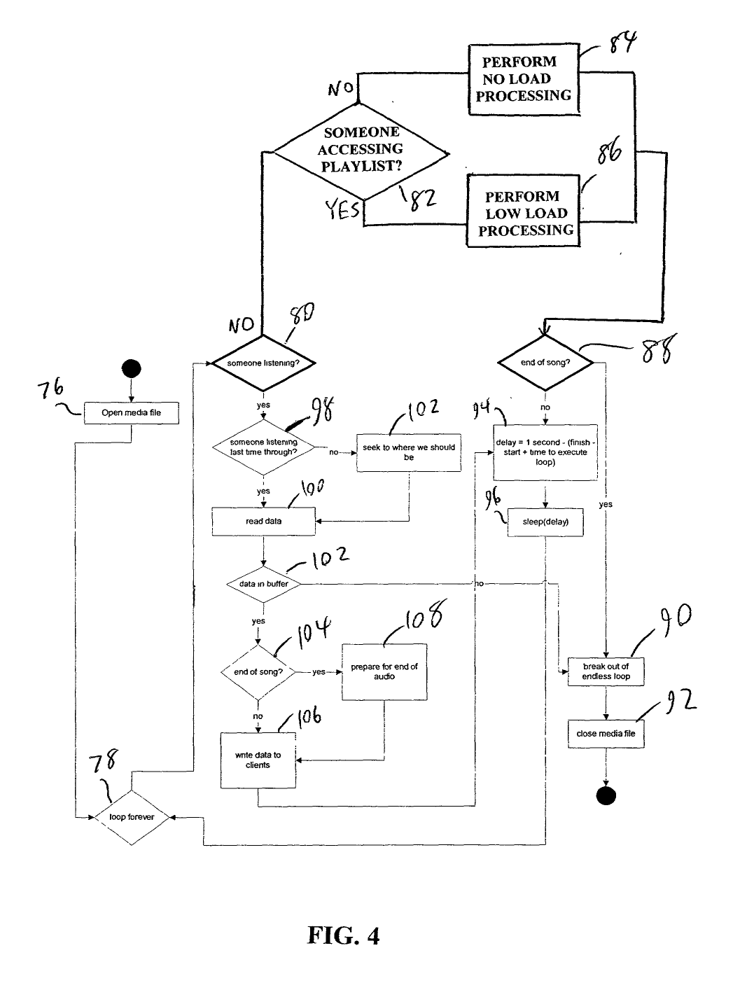

As shown in FIGS. 4-6, which illustrate an example of the method of operation of an instance of a streaming application for a given program to perform steps 68-74 in FIG. 3, the streaming server 38 implements an instance of the streaming application to open a media file in step 76 associated with the program, with the media file to be streamed to the accessing users/clients 16. The streaming application then loops forever in step 78 to stream the media file in the manner determined by the selected mode, as described herein. However, the streaming server 38 monitors in steps 80-82, to implement step 74 in FIG. 3, to determine if anyone is accessing/listening to the streamed media file and to determine if anyone is accessing a playlist of the program, respectively.

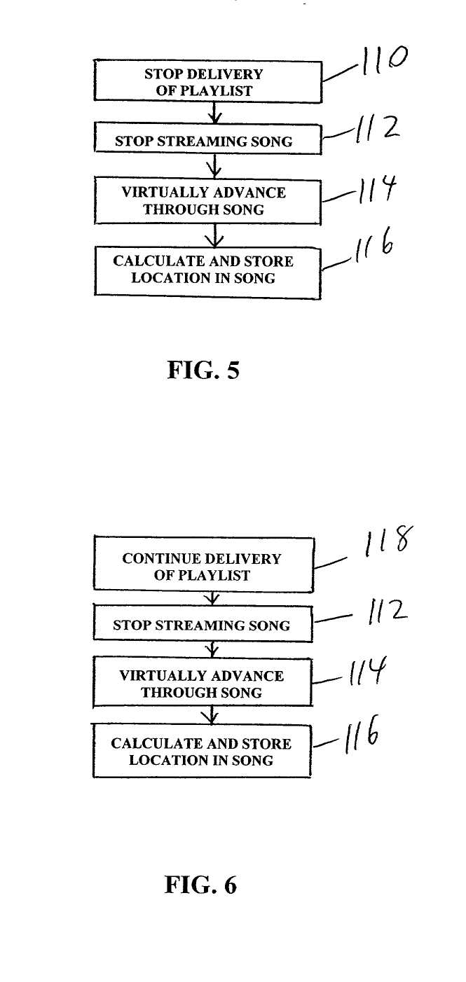

In step 80, if no one is listening to the opened media file, the streaming application determines in step 82 if someone is accessing the playlist of the program including the media file. If no one is accessing the playlist and, as already determined in step 80, is not accessing the media file, the streaming application performs no load processing in step 84, shown in greater detail in FIG. 5. However, if someone is accessing the playlist in step 82 but is not accessing the media file as previously determined in step 80, then the streaming application performs low load processing in step 86, shown in greater detail in FIG. 6.

After either of steps 84-86, the streaming application proceeds to step 88 to determine if the end of the song had been reached, which may be one reason why listeners have stopped listening to the program, and then the streaming application breaks out of the endless loop in step 90 and closes the media file in step 92.

If the end of the song had not been reached in step 88, the streaming application determines in step 94 a delay, for example, by deducting from the sum of one second plus the start time, the sum of the finish time and the time to execute the loop step 78. The streaming application then executes a sleep or delay procedure in step 96, for example, to re-synchronize the processing of the media file with the looping step 78, and the method proceeds to step 78.

However, if it is determined in step 80 that someone is listening to the given program and its associated media file, then the streaming application determines in step 98 if the listener is accessing the song in the media file a last time through. If so, the streaming application reads the data of the media file to a data buffer in step 100 for streaming to the user at an associated client; otherwise, the streaming application determines in the media file in step 102 where the streaming server should be, to read the data of the media file to the data buffer in step 100 to be streamed to the user at the associated client.

After reading such data in step 100, if the streaming application determines in step 102 that there is no data in the buffer, for example, if all of the songs in the program have been read out to the buffer, then the streaming application proceeds to steps 90-92 to break out of the loop and to close the media file, respectively.

However, if there is still data in the buffer as determined in step 102, the streaming application determines if the end of the song has been reached in step 104. If not, the buffered data is written in step 106 to the requesting clients 16; that is, it is streamed to the clients 16 over the Internet 14 and/or other network distribution devices, and the streaming application proceeds to steps 94-96 to continue looping in step 78 to continue to stream data to the requesting clients 16, if available and if the load conditions have changed by user action; that is, no long accessing or listening.

Otherwise, if the song has ended in step 104, the streaming application prepares in step 108 for the end of the song/audio data, for example, by inserting an end-of-file (EOF) code or other data into the streamed data for detection and action by the client 16. The streaming application proceeds to step 106 to write the song data and/or the EOF code to the clients 16, and the streaming application proceeds to steps 94-96.

As described herein, the streaming application performs low or zero/no load processing in FIG. 4, as described in greater detail in FIGS. 5 and 6. Referring to FIG. 5, for zero or no load operation, for a given program having an associated stream or streams, no stream processing or directory delivery is performed at all by the streaming server 38 when there are no listeners/viewers for the particular program and its associated streams. In addition, the streaming application, executed by the respective streaming server 38 and associated with the particular program, does not attempt to read data from audio files for the particular program, but the associated streaming application keeps track of where the streaming application should be in that file.

When a listener does connect, a calculation is performed to determine what track should be delivered to the user. The calculation is performed by using the stored playlist which includes the knowledge of the length of each track, the period of “off” time that is required to link one track with the subsequent one, and the time of the last connection to the stream which is recorded when the last person disconnects from the stream. The proper track to deliver is calculated by comparing the time since the last connection to the sequence of tracks in the playlist, and determining which track would have been playing if the stream had been playing continuously. This calculation method is used upon connection for the first listener/viewer when the server was idle for some period of time, but all subsequent connections are handled by the normal live streaming logic. When a user connects to the associated streaming application to access the particular program, the associated streaming application jumps to the position where it should be, and starts to broadcast from that point on. In normal usage patterns, this optimization gives an order of magnitude increase in scalability.

Accordingly, step 84 in FIG. 4 is performed by the steps 110-116 in FIG. 5, in which the streaming application stops delivery of the un-accessed playlist in step 110, stops streaming the song in step 112, and virtually advances through the media file, such as audio data representing a song, in step 114, by calculating how long the media file has been streamed. The streaming application then calculates and stores in memory, in step 116, the location or time-point of the user in the song, which is used in step 94 described herein. The streaming application then proceeds to step 88 in FIG. 4.

Similar to the no load processing method of FIG. 5, the low load processing method is shown in FIG. 6, in which the streaming server 38 does not run, but a memory or database associated with the streaming server 38 keeps track of information and synchronous data continues to be updated in real-time, which reduces the resources required to deliver this content by avoiding the need to read files from the file storage system, to move this data across the internal network, or to consume CPU time performing these operations. However, since the playlist 46 is being actively read from the playlist server 44, a limited amount of CPU time is consumed reading this data and updating the synchronous data list.

Accordingly, step 86 in FIG. 4 is performed by steps 112-118, in which the streaming application continues in step 118 to delivery the playlist to the requesting/accessing user or client 16, and the streaming application performs steps 112-116, as described herein, to stop streaming the song yet track the location and/or time-point of the client in the song. The streaming application then proceeds to step 88.

The directory server 34 is periodically contacted by the streaming server 38 to report current listener counts and other data. When a very large number of servers are operated and these updates are frequent, a very high load can be imposed on the directory server 34 and the station database 36 in which the station/program data are stored. In the present invention, the streaming servers 38 only contact the directory server 34 when there are user connections or request to the streaming server 38.

Additionally, when a large number of users are requesting access to the directory, a large number of pages (HTML, XML, or ASCII data) need to be delivered. Since many of these requests are repetitive, the current invention includes the caching of requests and results to eliminate repetitive queries from being submitted to the station database 36 and/or media database 40.

The playlist server 44 is contacted by the streaming server 38 whenever a new track or playlist entry begins playing. When a very large number of streams are delivered to a large number of users, a very large number of playlists must be generated. In the current invention, if a station has no connected users, the playlist need not be generated.

### Use of Application Program Interfaces

To implement the disclosed stream delivery system and method described herein, the streaming application is constructed to implement known multithreaded technology that takes full advantage of SMP computer architectures, which ensures that the streaming application can handle several tasks while providing un-interrupted audio delivery to its clients. Each instance of streaming application may be integrated with the “LIVE365” website by sending periodic status to services built to interface with a central database. The streaming application can notify a service when it starts, when users connect and disconnect, and when the source changes.

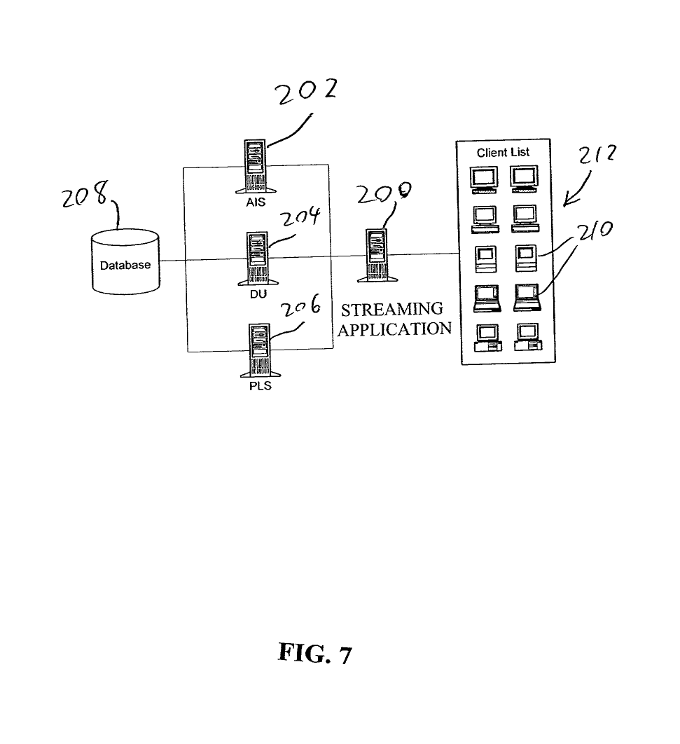

As shown in an example embodiment in FIG. 7, an instance 200 of the streaming application is running, and uses known application program interfaces (APIs) and known hypertext transfer protocol (HTTP) interface technology to send updates. For example, the instance 200 of the streaming application operates an audio insertion server (AIS) API to communicate with an AIS 202, operates a disk update (DU) API to communicate with a DU server 204, and operates a playlist server (PLS) API to communicate with a PLS server 206 and so to interface with one or more databases 208 to serve a plurality of clients 210 in a client list 212.

In one embodiment, the PLS API sends audio track information to the PLS server 206 which tracks the ID3 information contained in MP3 files. The PLS server 206 and other services may be coordinated to supply matching banner advertisements to provide a consistent audible and visual experience.

The streaming application supports a known AIS API to communicate with an AIS 202 to deliver an inserted personal online desktop (POD) software component, such as a window process and/or a “MICROSOFT ACTIVEX” control, either between audio clips or when a client connects, for example, to display a window or screen message having an advertisement. Advertising campaigns can be coordinated with the AIS 202 which tells the streaming application 200 what to play and when to play them. The streaming application 200 logs all relevant information including time played and listener count for individual insert PODs. The streaming application 200 also allows the block of inserts to be augmented with a station identification (station ID) set in the configuration file.

The API associated with instances of the streaming application is a set of commands which may be sent to the streaming application to control the behavior of the streaming application or to query its current state. The streaming application API is the basis for communicating with media player technology to facilitate on-demand audio through software-generated players, for example, pop-up windowed applications for playing media through an Internet browser. The API uses standard HTTP URL syntax, facilitating ease of construction of high level interfaces to control the streaming application.

The API uses three handlers, each one has distinct functionality, and is separated by modes of authority, as shown in Tables 1-3 herein. The admin handler is responsible for initialization of the streaming application to either load a new configuration or query the loaded configuration. The control handler is responsible for random access through a playlist or audio track and to mimic consumer grade compact disc players. The play handler is responsible for listen authentication on a stream.

The streaming application has the ability to be used as an on-demand streaming server. The streaming application can be instructed to load a playlist of clips, and wait idle until a listener connects. In the on-demand mode and through the streaming application API, the streaming application may be controlled externally to skip forward or backward through an audio clip. In on-demand mode, the streaming application has the ability to jump to any song in a playlist. The streaming application may be instructed to set a session ID for a broadcast, and the streaming application then starts the audio. On-demand mode may also provide restricted access to an audio stream according to session ID.

The streaming application API consists of a set of commands which may be sent to the streaming application to change its behavior immediately. The API is invoked through a standard HTTP connection, making it easy to control.

Example API Commands are shown in Tables 1-3. Table 1 illustrates administrative (admin) commands, Table 2 illustrates a play command, and Table 3 illustrates control commands.

TABLE 1

| | |
|---|---|
| password | Password used to execute any of the following |
| | commands. It is the admin password specified in the |
| | configuration file. |
| session | Set the session key for subsequent control and play |
| | handlers. |
| station | Broadcaster name, if no parameter is specified, this |
| | directive will report back the current broadcaster name. |
| description | Stream description, if no parameter is specified, this |
| | directive will report back the current stream |
| | description. |
| playlistFile | If no parameter is specified, this directive will report |
| | back the current playlist file. If the parameter is |
| | specified and the operation is successful, this directive |
| | will report the name of the specified playlist file. |
| initialize | This directive queues the current playlist from the start |
| | of the playlist immediately, and generally sets up the |
| | broadcast for a new station. |
| bytesPerSecond | Bytes transferred in this cycle. Periodically this value |
| | is reset by a different thread. The reset value is −1. |
| | If a client receives this as the value of the statistic, |
| | resample. |
| numListeners | Number of listeners on this broadcast. |
| qpas | Specifying this parameter will cause NC to queue the |
| | current playlist after the current song. |
| streamStartTime | Unix time that the stream was started |
| pre | Specifying this parameter will cause NC to output |
| | preformatted text in the response codes |

TABLE 2

| | |
|---|---|
| session | The value of this parameter must match the session |
| | control parameter set by the admin handler. |

TABLE 3

| | |
|---|---|
| session | Specifying this parameter with the same session value |
| | that was set by the admin interface will allow |
| | subsequent control commands to be executed. |
| seek | Specifying this value in the integer range 0-100 will |
| | seek to position in the current audio track. |
| stop | Reloads the playlist from the beginning, it is up to the |
| | client to close the connection, it will report to the clerk |
| | that the IP/port can be re-allocated if necessary. |
| pause | Stops the stream and remembers the progress in the |
| | playlist and file, it reports to the clerk that the IP/port |
| | can be re-allocated if necessary. |
| term | Same as stop, except that it reports to the clerk that the |
| | IP/port must be re-allocated. |
| getPlaylistLength | This parameter will return the number of audio tracks |
| | in the current playlist. |
| jumpToIndex | Specifying a value greater than 0 and less than the |
| | number of songs in the current playlist queues up the |
| | song indicated by the index and jump to that song. |
| songStat | Returns current progress of audio track in percentage, |
| | current audio track length in seconds, and current |
| | playlist index value. example: |
| | songStat.progress = 0 |
| | songStat.total = 170 |
| | songStat.index = 1 |
| | songStat.filename = SWilson_plays_guitar.mp3 |
| scriptSongStat | Returns current progress of audio track in percentage, |
| | current playlist index value and return code in |
| | JavaScript output. Example: |
| | <script language = “JavaScript”> |
| | var iCurrentPos = 9; |
| | var iSong = 1; |
| | var iResponse = 0; |
| | var filename = SWilson_plays_guitar.mp3; |
| | </script> |

What is claimed is:

1. A streaming data delivery system comprising:
a stream database for storing a plurality of data as a program to be transmitted in a stream over a communications network, and for storing characteristic information about the stream;
a directory server for storing a list of the program and the associated stream which is available to stream over the communications network; and
a streaming server, responsive to the characteristic information, the list, and a load condition of the streaming server associated with the stream and the list, for the controlling the streaming of the stream and the delivery of its associated list over the communications network.

2. The streaming data delivery system of claim 1, wherein the streaming server operates in a first mode of a plurality of modes for controlling the streaming of the data.

3. The streaming data delivery system of claim 2, wherein the plurality of modes includes:
a looping mode;
a relay mode;
a live-broadcast mode; and
an on-demand mode.

4. The streaming data delivery system of claim 3, wherein in the looping mode, the relay mode, or the live-broadcast mode, the streaming server transmits a common stream having identical data to each of a plurality of users.

5. The streaming data delivery system of claim 3, wherein the streaming server transmits, in the on-demand mode, a plurality of streams to a plurality of users, with each user receiving a respective individualized stream from the plurality of streams.

6. The streaming data delivery system of claim 1, wherein the stream database stores the plurality of data as a plurality of streams, including a first stream; and
wherein the streaming server, responsive to a first load condition associated with the first stream, stops the streaming of the first stream over the communications network and controls the delivery of the list associated with the first stream over the communication network.

7. The streaming data delivery system of claim 6, wherein the first load condition corresponds to zero load with no users accessing the first stream; and
wherein the streaming server controls the delivery of the list by not sending the list over the communications network.

8. The streaming data delivery system of claim 6, wherein the first load condition corresponds to a low load with at least one user accessing the list and with no users accessing the first stream; and
wherein the streaming server controls the delivery of the list by updating the list and by sending the list over the communications network to the at least one user.

9. A system for providing streaming data to a user, the system comprising:
a client device associated with the user including:
a processor for sending data requests over a communications network and for receiving data in streams from the communications network;
the communications network being connected to the client device for transmitting data requests and streamed data; and
a streaming data delivery apparatus, connected to the communications network for communicating to the client device through the communications network, the streaming data delivery apparatus including:
a stream database for storing a plurality of data as a program to be transmitted in a stream over the communications network, and for storing characteristic information about the stream, wherein the plurality of data includes at least one of audio data, video data, multimedia data, and text data;
a directory server for storing a list of the program and the associated stream which is available to stream over the communications network; and
a streaming server, responsive to a data request from the user, the characteristic information, the list, and a load condition of the streaming server associated with the stream and the list, for the controlling the streaming of the stream and the delivery of its associated list to the client device over the communications network.

10. The system of claim 9, wherein the streaming server operates in a first mode of a plurality of modes for controlling the streaming of the data.

11. The system of claim 10, wherein the plurality of modes includes:
a looping mode;
a relay mode;
a live-broadcast mode; and
an on-demand mode.

12. The system of claim 11, wherein in the looping mode, the relay mode, or the live-broadcast mode, the streaming server transmits a common stream having identical data to each of a plurality of users.

13. The system of claim 11, wherein the streaming server transmits, in the on-demand mode, a plurality of streams to a plurality of users, with each user receiving a respective individualized stream from the plurality of streams.

14. The system of claim 9, wherein the stream database stores the plurality of data as a plurality of streams, including a first stream; and
wherein the streaming server, responsive to a first load condition associated with the first stream, stops the streaming of the first stream over the communications network to the client device, and controls the delivery of the list associated with the first stream over the communication network to the client device.

15. The system of claim 14, wherein the first load condition corresponds to zero load with no users sending respective data requests for accessing the first stream; and
wherein the streaming server controls the delivery of the list by not sending the list over the communications network.

16. The system of claim 14, wherein the first load condition corresponds to a low load with at least one user sending an associated data request to access the list and with no users accessing the first stream; and
wherein the streaming server controls the delivery of the list by updating the list and by sending the list over the communications network to the client device associated with the at least one user.

17. A method for streaming data comprising the steps of:
storing a plurality of data as a program in a stream database to be transmitted in a stream over a communications network;
storing characteristic information about the stream in the stream database;
storing, in a directory server, a list of the program and the associated stream which is available to stream over the communications network; and
controlling the streaming of the stream from a streaming server and the delivery of its associated list over the communications network, including the steps of:
accessing the stream database for the characteristic information about the stream;
accessing the directory server for the list associated with the stream;
evaluating a load condition of the streaming server associated with the stream and the list; and
streaming the stream and delivering the list in response to the characteristic information, the list, and the load condition.

18. The method of claim 17, wherein the step of controlling includes the step of:
operating in a first mode of a plurality of modes selected from:
a looping mode;
a relay mode;
a live-broadcast mode; and
an on-demand mode.

19. The method of claim 18, wherein in the looping mode, the relay mode, or the live-broadcast mode, the step of controlling includes the step of:
transmitting, from the streaming server, a common stream having identical data to each of a plurality of users.

20. The method of claim 18, wherein in the on-demand mode, the step of controlling includes the step of:
transmitting, from the streaming server, a plurality of streams to a plurality of users, with each user receiving a respective individualized stream from the plurality of streams.

21. The method of claim 17, wherein the step of storing the plurality of data includes the step of:
storing the plurality of data as a plurality of streams, including a first stream; and
wherein the step of evaluating the load condition includes the step of:
responding to a first load condition associated with the first stream to perform the steps of:
stopping the streaming of the first stream over the communications network; and
controlling the delivery of the list associated with the first stream over the communication network.

22. The method of claim 21, wherein the first load condition corresponds to zero load with no users accessing the first stream; and
wherein the step of controlling delivery of the list includes the step of:
preventing the delivery of the list over the communications network.

23. The method of claim 21, further comprising the step of:
receiving a request for the list associated with the first stream from at least one user;
wherein the first load condition corresponds to a low load with at least one user accessing the list and with no users accessing the first stream; and
wherein the step of controlling the delivery of the list includes the steps of:
updating the list; and
sending the list over the communications network to the at least one user.
